(19) United States
(12) Patent Application Publication
(10) Pub. No.: US 2015/0089189 A1
(43) Pub. Date: Mar. 26, 2015

(54) Predicate Vector Pack and Unpack Instructions

(71) Applicant: APPLE INC., CUPERTINO, CA (US)

(72) Inventor: Jeffry E. Gonion, Campbell, CA (US)

(73) Assignee: APPLE INC., CUPERTINO, CA (US)

(21) Appl. No.: 14/034,629

(22) Filed: Sep. 24, 2013

(51) Int. Cl. G06F 9/30

(52) U.S. Cl. CPC G06F 9/30036; G06F 9/30098
USPC 712/4

(57) ABSTRACT

In an embodiment, a processor may implement a vector instruction set including predicate vectors and multiple vector element sizes. The vector instruction set may include predicate vector pack and unpack instructions. Responsive to the predicate vector pack instruction, the processor may pack predicates from multiple predicate vector source registers into a destination predicate vector register. Responsive to the predicate vector unpack instruction, the processor may select a portion of a source predicate vector register and write the result to a destination predicate vector register. Additionally, the predicate vector register may store one or more vector attributes associated with the corresponding vector. The processor may modify the attribute as part of the pack/unpack operation (e.g. based on a pack/unpack factor). Additionally, vector pack/unpack instructions that are controlled by the attribute in a corresponding predicate vector register may be implemented.

### BACKGROUND

1. Field of the Invention

This invention is related to the field of processors and, more particularly, to processors that execute predicated vector operations.

2. Description of the Related Art

Recent advances in processor design have led to the development of a number of different processor architectures. For example, processor designers have created superscalar processors that exploit instruction-level parallelism (ILP), multi-core processors that exploit thread-level parallelism (TLP), and vector processors that exploit data-level parallelism (DLP). Each of these processor architectures has unique advantages and disadvantages which have either encouraged or hampered the widespread adoption of the architecture. For example, because ILP processors can often operate on existing program code, these processors have achieved widespread adoption. However, TLP and DLP processors typically require applications to be manually re-coded to gain the benefit of the parallelism that they offer, a process that requires extensive effort. Consequently, TLP and DLP processors have not gained widespread adoption for general-purpose applications.

In general, vector processors execute instructions that operate on vector operands. Each vector operand is a set of vector elements, and the operation defined for the vector instruction is generally performed in parallel on each vector element. Accordingly, the amount of parallelism that can be achieved in a vector processor is dependent on the number of vector elements in a vector, which depends on the size of the vector and the size of the vector elements. On the other hand, the size of the vector element affects the range of values that can be represented by the vector element. Larger vector element sizes are needed for some values, while smaller element sizes can be used for others.

Differently-sized vector elements are supported to permit higher parallelism when smaller element sizes are sufficient and to permit larger element sizes when needed. There are cases where the element sizes need to be converted from one size to another. Converting from a smaller element size to a larger element size involves generating multiple vectors of the larger element size with vector elements from corresponding portions of the smaller element size (referred to as unpacking) Converting from a larger element size to a smaller element size involves generating one vector of the smaller element size out of vector elements from multiple vectors of the larger element size (referred to as packing).

### SUMMARY

In an embodiment, a processor may implement a vector instruction set including predicate vectors and multiple vector element sizes. The predicate vector may be a vector of predicate values, one predicate value for each vector element in a corresponding vector. The predicate value may indicate if the corresponding vector element is active (operated upon by the vector instruction) or inactive (not operated upon by the vector instruction). In an embodiment, the vector instruction set includes predicate vector pack and unpack instructions. Responsive to the predicate vector pack instruction, the processor may pack predicates from multiple predicate vector source registers into a destination predicate vector register. Responsive to the predicate vector unpack instruction, the processor may select a portion of a source predicate vector register and write the result to a destination predicate vector register. Additionally, the predicate vector register may store one or more vector attributes associated with the corresponding vector. The processor may modify the attribute as part of the pack/unpack operation (e.g. based on a pack/unpack factor). Additionally, vector pack/unpack instructions that are controlled by the attribute in a corresponding predicate vector register may be implemented.

### BRIEF DESCRIPTION OF THE DRAWINGS

The following detailed description makes reference to the accompanying drawings, which are now briefly described.

FIG. 1 is a block diagram of one embodiment of a computer system.

FIG. 2 is a block diagram of one embodiment of predicate vector registers and vector registers.

FIG. 3 illustrates several embodiments of pack/unpack instructions.

FIG. 4 is a block diagram illustrating examples of predicate vector pack and unpack.

FIG. 5 is a flowchart illustrating operation of one embodiment of a processor that implements a predicate vector pack instruction.

FIG. 6 is a flowchart illustrating operation of one embodiment of a processor that implements a predicate vector unpack instruction.

FIG. 7 is a flowchart illustrating operation of one embodiment of a processor that implements a vector pack instruction.

FIG. 8 is a flowchart illustrating operation of one embodiment of a processor that implements a vector unpack instruction.

FIG. 9 is a diagram illustrating an example parallelization of a program code loop.

FIG. 10A is a diagram illustrating a sequence of variable states during scalar execution of the loop shown in Example 1.

FIG. 10B is a diagram illustrating a progression of execution for Macroscalar vectorized program code of the loop of Example 1.

FIG. 11A and FIG. 11B are diagrams illustrating one embodiment of the vectorization of program source code.

FIG. 12A is a diagram illustrating one embodiment of non-speculative vectorized program code.

FIG. 12B is a diagram illustrating another embodiment of speculative vectorized program code.

FIG. 13 is a diagram illustrating one embodiment of vectorized program code.

FIG. 14 is a diagram illustrating another embodiment of vectorized program code.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

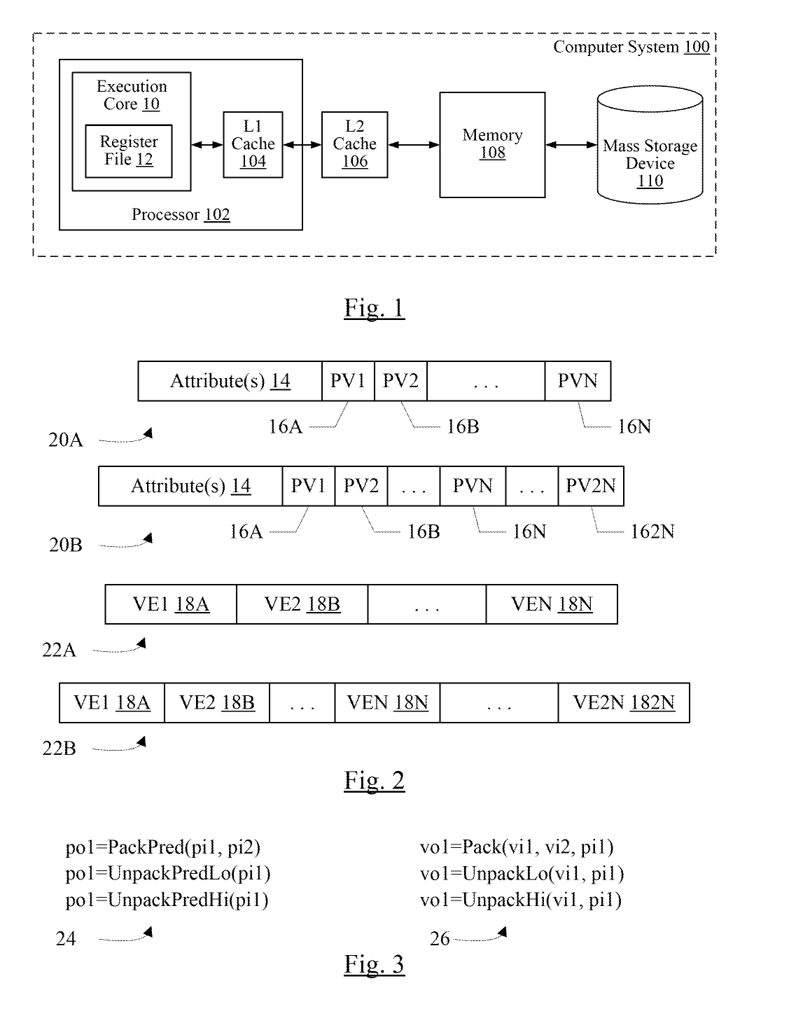

Turning now to FIG. 1, a block diagram of one embodiment of a computer system is shown. Computer system 100 includes a processor 102, a level two (L2) cache 106, a memory 108, and a mass-storage device 110. As shown, processor 102 includes a level one (L1) cache 104 and an execution core 10 coupled to the L1 cache 104. The execution core 10 includes/is coupled to a register file 12 as shown. It is noted that although specific components are shown and described in computer system 100, in alternative embodiments different components and numbers of components may be present in computer system 100. For example, computer system 100 may not include some of the memory hierarchy (e.g., memory 108 and/or mass-storage device 110). Multiple processors similar to the processor 102 may be included. Additionally, although the L2 cache 106 is shown external to the processor 102, it is contemplated that in other embodiments, the L2 cache 106 may be internal to the processor 102. It is further noted that in such embodiments, a level three (L3) cache (not shown) may be used. In addition, computer system 100 may include graphics processors, video cards, video-capture devices, user-interface devices, network cards, optical drives, and/or other peripheral devices that are coupled to processor 102 using a bus, a network, or another suitable communication channel (all not shown for simplicity).

In various embodiments, the processor 102 may be representative of a general-purpose processor that performs computational operations. For example, the processor 102 may be a central processing unit (CPU) such as a microprocessor, a microcontroller, an application-specific integrated circuit (ASIC), or a field-programmable gate array (FPGA). The processor 102 may include one or more mechanisms for vector processing (e.g., vector execution units). The processor 102 may be a standalone component, or may be integrated onto an integrated circuit with other components (e.g. other processors, or other components in a system on a chip (SOC)). The processor 102 may be a component in a multichip module (MCM) with other components.

More particularly, as illustrated in FIG. 1, the processor 102 may include the execution core 10. The execution core 10 may be configured to execute instructions defined in an instruction set architecture implemented by the processor 102. The execution core 10 may have any microarchitectural features and implementation features, as desired. For example, the execution core 10 may include superscalar or scalar implementations. The execution core 10 may include in-order or out-of-order implementations, and speculative or non-speculative implementations. The implementations may include microcode, in some embodiments. Any combination of the above embodiments may be implemented. The execution core 10 may include a variety of execution units, each execution unit configured to execute operations of various types (e.g. integer, floating point, vector, multimedia, load/store, etc.). The execution core 10 may include different numbers pipeline stages and various other performance-enhancing features such as branch prediction. The execution core 10 may include one or more of instruction decode units, schedulers or reservations stations, reorder buffers, memory management units, I/O interfaces, etc.

The register file 12 may include a set of registers that may be used to store operands for various instructions. The register file 12 may include registers of various types, based on the type of operand the execution core 10 is configured to store in the registers (e.g. integer, floating point, multimedia, vector, etc.). The register file 12 may include architected registers (i.e. those registers that are specified in the instruction set architecture implemented by the processor 102). Alternatively or in addition, the register file 12 may include physical registers (e.g. if register renaming is implemented in the execution core 10). There may also be multiple register files 12 (e.g. there may be separate register files for each operand type).

The L1 cache 104 may be illustrative of any caching structure. For example, the L1 cache 104 may be implemented as a Harvard architecture (separate instruction cache for instruction fetching by the fetch unit 201 and data cache for data read/write by execution units for memory-referencing ops), as a shared instruction and data cache, etc. In some embodiments, load/store execution units may be provided to execute the memory-referencing ops.

An instruction may be an executable entity defined in an instruction set architecture implemented by the processor 102. There are a variety of instruction set architectures in existence (e.g. the x86 architecture original developed by Intel, ARM from ARM Holdings, Power and PowerPC from IBM/Motorola, etc.). Each instruction is defined in the instruction set architecture, including its coding in memory, its operation, and its effect on registers, memory locations, and/or other processor state. A given implementation of the instruction set architecture may execute each instruction directly, although its form may be altered through decoding and other manipulation in the processor hardware. Another implementation may decode at least some instructions into multiple instruction operations for execution by the execution units in the processor 102. Some instructions may be microcoded, in some embodiments. Accordingly, the term “instruction operation” may be used herein to refer to an operation that an execution unit in the processor 102/execution core 10 is configured to execute as a single entity. Instructions may have a one to one correspondence with instruction operations, and in some cases an instruction operation may be an instruction (possibly modified in form internal to the processor 102/execution core 10). Instructions may also have a one to more than one (one to many) correspondence with instruction operations. An instruction operation may be more briefly referred to herein as an “op.”

The mass-storage device 110, memory 108, L2 cache 10, and L1 cache 104 are storage devices that collectively form a memory hierarchy that stores data and instructions for processor 102. More particularly, the mass-storage device 110 may be a high-capacity, non-volatile memory, such as a disk drive or a large flash memory unit with a long access time, while L1 cache 104, L2 cache 106, and memory 108 may be smaller, with shorter access times. These faster semiconductor memories store copies of frequently used data. Memory 108 may be representative of a memory device in the dynamic random access memory (DRAM) family of memory devices. The size of memory 108 is typically larger than L1 cache 104 and L2 cache 106, whereas L1 cache 104 and L2 cache 106 are typically implemented using smaller devices in the static random access memories (SRAM) family of devices. In some embodiments, L2 cache 106, memory 108, and mass-storage device 110 are shared between one or more processors in computer system 100.

In some embodiments, the devices in the memory hierarchy (i.e., L1 cache 104, etc.) can access (i.e., read and/or write) multiple cache lines per cycle. These embodiments may enable more effective processing of memory accesses that occur based on a vector of pointers or array indices to non-contiguous memory addresses.

It is noted the data structures and program instructions (i.e., code) described below may be stored on a non-transitory computer-readable storage device, which may be any device or storage medium that can store code and/or data for use by a computer system (e.g., computer system 100). Generally speaking, a non-transitory computer-readable storage device includes, but is not limited to, volatile memory, non-volatile memory, magnetic and optical storage devices such as disk drives, magnetic tape, compact discs (CDs), digital versatile discs or digital video discs (DVDs), or other media capable of storing computer-readable media now known or later developed. As such, mass-storage device 110, memory 108, L2 cache 10, and L1 cache 104 are all examples of non-transitory computer readable storage devices.

As mentioned above, the execution core 10 may be configured to execute vector instructions. The vector instructions may be defined as single instruction-multiple-data (SIMD) instructions in the classical sense, in that they may define the same operation to be performed on multiple data elements in parallel. The data elements operated upon by an instance of an instruction may be referred to as a vector. However, it is noted that in some embodiments, the vector instructions described herein may differ from other implementations of SIMD instructions. For example, in an embodiment, elements of a vector operated on by a vector instruction may have a size that does not vary with the number of elements in the vector. By contrast, in some SIMD implementations, data element size does vary with the number of data elements operated on (e.g., a SIMD architecture might support operations on eight 8-bit elements, but only four 16-bit elements, two 32-bit elements, etc.).

In one embodiment, the register file 12 may include vector registers that can hold operand vectors and result vectors. In some embodiments, there may be 32 vector registers in the vector register file, and each vector register may include 128 bits. However, in alternative embodiments, there may be different numbers of vector registers and/or different numbers of bits per register. The vector registers may further include predicate vector registers that may store predicates for the vector instructions, and may also store one or more vector attributes as described in further detail below. Furthermore, embodiments which implement register renaming may include any number of physical registers that may be allocated to architected vector registers and architected predicate vector registers. Architected registers may be registers that are specifiable as operands in vector instructions.

In one embodiment, the processor 102 may support vectors that hold N data elements (e.g., bytes, words, doublewords, etc.), where N may be any positive whole number. In these embodiments, the processor 102 may perform operations on N or fewer of the data elements in an operand vector in parallel. For example, in an embodiment where the vector is 256 bits in length, the data elements being operated on are four-byte elements, and the operation is adding a value to the data elements, these embodiments can add the value to any number of the elements in the vector. It is noted that N may be different for different implementations of the processor 102.

In some embodiments, as described in greater detail below, based on the values contained in a vector of predicates or one or more scalar predicates, the processor 102 applies vector operations to selected vector data elements only. In some embodiments, the remaining data elements in a result vector remain unaffected (which may also be referred to as “masking” or “masking predication”) or are forced to zero (which may also be referred to as “zeroing” or “zeroing predication”). In some embodiments, the clocks for the data element processing subsystems (“lanes”) that are unused due to predication or zeroing in the processor 102 can be power and/or clock-gated, thereby reducing dynamic power consumption in the processor 102. Generally a predicate may refer to a value that indicates whether or not an operation is to be applied to a corresponding operand value to produce a result. A predicate may, e.g., be a bit indicating that the operation is to be applied in one state and not applied in the other state. For example, the set state may indicate that the operation is to be applied and the clear state may indicate that the operation is not to be applied (or vice versa). Elements that are to be operated upon according to the predicate may be referred to as active elements, while elements that are not to be operated upon according to the predicate may be referred to as inactive elements.

In various embodiments, the architecture may be vector-length agnostic to allow it to adapt to parallelism at runtime. More particularly, when instructions or ops are vector-length agnostic, the operation may be executed using vectors of any length. A given implementation of the supporting hardware may define the maximum length for that implementation. For example, in embodiments in which the vector execution hardware supports vectors that can include eight separate four-byte elements (thus having a vector length of eight elements), a vector-length agnostic operation can operate on any number of the eight elements in the vector. On a different hardware implementation that supports a different vector length (e.g., four elements), the vector-length agnostic operation may operate on the different number of elements made available to it by the underlying hardware. Thus, a compiler or programmer need not have explicit knowledge of the vector length supported by the underlying hardware. In such embodiments, a compiler generates or a programmer writes program code that need not rely on (or use) a specific vector length. In some embodiments it may be forbidden to specify a specific vector size in program code. Thus, the compiled code in these embodiments (i.e., binary code) runs on other execution units that may have differing vector lengths, while potentially realizing performance gains from processors that support longer vectors. In such embodiments, the vector length for a given hardware unit such as a processor may be read from a system register during runtime. Consequently, as process technology allows longer vectors, execution of legacy binary code simply speeds up without any effort by software developers.

Generally, vector lengths may be implemented as powers of two (e.g., two, four, eight, etc.). However, in some embodiments, vector lengths need not be powers of two. Specifically, vectors of three, seven, or another number of data elements can be used in the same way as vectors with power-of-two numbers of data elements.

The processor 102 may support multiple vector element sizes, and the instruction set architecture may define pack/unpack instructions to convert vectors between the element sizes. Additionally, the instruction set architecture may include predicate pack/unpack instructions. If vectors are being packed/unpacked, the predicate vectors associated with those vectors may need to be packed/unpacked as well. The predicate pack instruction may specify two or more source predicate vector registers from which predicates are to be packed, and a destination register into which the packed predicate vectors are to be stored. The processor 102 may be configured to concatenate the predicate vectors to form the result predicate vector, and may write the result to the destination predicate vector register. Additionally, embodiments that include vector attributes in the predicate vector registers may modify the attributes based on the packing/unpacking being performed and further based on the definition of the attributes.

For the vector pack/unpack instructions, the vector attribute(s) from corresponding predicate vector registers may control the size of the packing/unpacking operations. That is, rather than the encoding of the instruction determining the pack/unpack sizes, the vector attribute may control the size. In this fashion, only one vector pack instruction encoding and one vector unpack instruction encoding need by specified in the instruction set architecture to cover any vector element sizes. In an exemplary usage model, the predicate vector pack/unpack instructions may be executed first and then the corresponding vector pack/unpack instructions may be executed. If the pack/unpack operations modify the vector attribute(s), the modified attributes may be used in the subsequent vector pack/unpack operations.

While the instruction set architecture may specify that vector instructions are vector length agnostic, vector attributes may be useful to the vector hardware. In an embodiment, the predicate vector registers may store both the predicates and one or more vector attributes for the corresponding vector operation. The vector attribute may generally specify any architected and/or implementation-specific size information. For example, in an embodiment, vector attributes may specify at least one of a vector element size (specifying one of a set of supported vector element sizes for a particular operation), vector size (e.g. size of the vector registers, e.g. in bits or bytes), number of vector elements per vector, number of elements per partition, number of partitions per vector, or partition size. A partition may be a subset of a vector on which certain operations are defined to operate. For example, a vector operation that reverses the order of the vector elements may operate on partitions within the vector register, reversing the order within each partition.

In an embodiment, the predicate vector registers may be architected to store one or more vector attributes, and the vector registers may store vector elements. FIG. 2 is a block diagram illustrating two exemplary predicate vector registers 20A and 20B and two exemplary vector registers 22A and 22B as architected according to one embodiment of the instruction set architecture implemented by the processor 102. As illustrated in FIG. 2, the predicate vector register 20A includes an attributes field 14 and N predicate fields 16A-16N. The N predicate fields correspond to the N vector element fields 18A-18N of the vector register 22A. Another architected predicate vector register 20B may include 2N predicate fields 16A-162N, and a corresponding vector register 22B may have 2N vector element fields 18A-182N. The registers 20A and 22A may, for example, correspond to a first vector element size and the registers 20B and 22B may correspond to a second vector element size that is ½ of the first vector element size. If the vector length is constant (e.g. equal to the number of bits in a given vector register in the register file 12), there are twice as many vector elements in a vector having the second vector element size than there are in a vector having the first vector element size.

In an embodiment, the predicate vector registers in the register file 12 may include enough storage to store a predicate vector of the maximum size supported by the processor 102. When the vector attributes indicate the predicate vector is shorter, only a portion of the predicate vector register may be used.

Some vector instructions may explicitly define vector attributes. That is, the encoding of the instruction itself (e.g. the opcode, one or more other fields of the instruction such as an immediate field, etc.) may specify the vector attribute. For example, an embodiment includes predicate vector initialization instructions, which are defined to initialize predicate vector registers with true predicates (predicates which cause the corresponding vector elements to be operated upon, e.g. the set state) or false predicates (predicates which cause the corresponding vector elements to not be operated upon, e.g. the clear state). The predicate vector initialization instructions may also explicitly specify the vector attributes. In an embodiment, memory-referencing instructions may explicitly specify vector attributes. Memory-referencing instructions may include loads (which read data from memory into registers, although the read may be accomplished in cache) and stores (which write data from registers to memory, although the write may be accomplished in cache). Since the vector attributes may affect the amount of memory that is read/written (e.g. the number of consecutive bytes at each vector location), the memory-referencing instructions may explicitly identify the vector attributes. In either case, the vector attributes in the predicate vector registers may be written based on the explicit updates.

The predicate pack and unpack instructions may also cause the vector attributes to be modified, as discussed above. In some embodiments, the vector attribute modifications may be relative (e.g. ½ or twice the current attribute). In other embodiments, the resulting vector element size may be specified by the instruction and thus the modification of the vector attribute may explicit in the predicate pack/unpack instructions or in a source operand of the instructions. Generally, a source operand may be an input to an instruction, which may be operated upon by an instruction to generate a result. A destination operand may be a location at which the result is to be written.

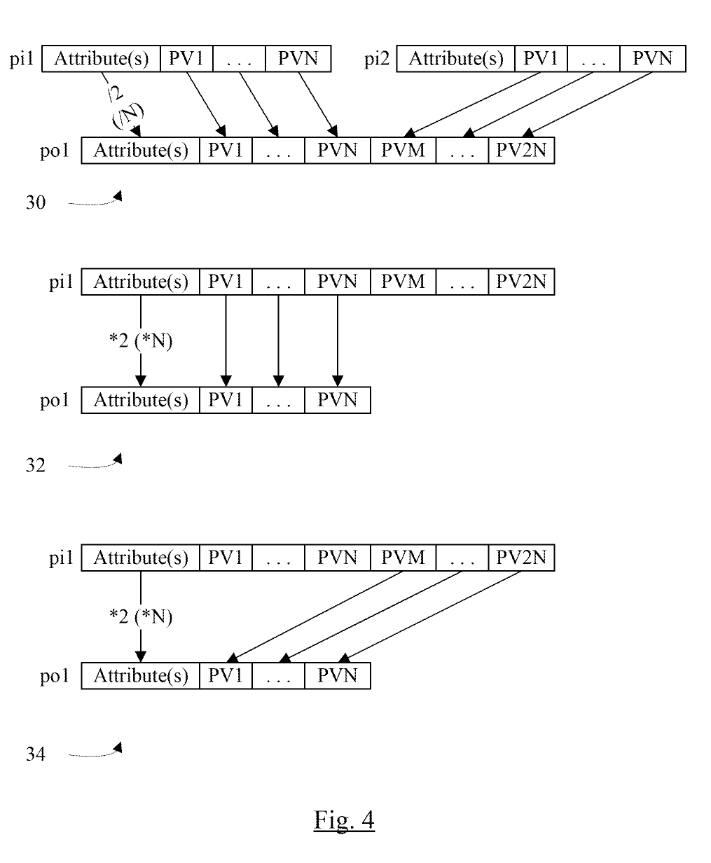

FIG. 3 is a diagram illustrating exemplary embodiments of predicate vector pack and unpack instructions and vector pack and unpack instructions that depend on a vector attribute. The predicate vector pack and unpack instructions are illustrated on the left (reference numeral 24) and the vector pack and unpack instructions are illustrated on the right (reference numeral 26). FIG. 4 is a diagram illustrating operation of the exemplary predicate vector pack and unpack instructions.

The predicate vector pack instruction (PackPred) may take two predicate vector registers as source operands (pi1 and pi2). The result of packing the predicate vectors from the two source operands may be written to the destination operand (predicate vector register po1). That is, the predicate vector from the first source operand may be concatenated with the predicate vector from the second source operand. Additionally, the vector attribute from the source operand pi1 may be written to the destination operand (possibly modified, depending on the definition of the vector attribute). At reference numeral 30 in FIG. 4, the concatenation of the first predicate vector (PV1 to PVN from pi1) with the second predicate vector (PV1 to PVN from pi2) to form the output predicate vector (PV1 to PV2N of po1) is illustrated. Additionally, a divide by 2 is illustrated for the attribute from pi1 to po1. In this embodiment, the vector attribute may be vector element size, and is divided by 2 to reflect the packing of two vectors into an output vector. Other embodiments may use number of vector elements, which would multiply by 2 to produce the output vector attribute. In some embodiments, e.g. vector size, the vector attribute may not change. Furthermore, other embodiments may pack more than two predicate vectors (e.g. N predicate vectors). In such cases, a divide by N or multiply by N may be used. N may be referred to as a pack factor, in some embodiments. The pack factor may be an indication of the amount of reduction in each vector element, for example. Similarly, N may be an unpack factor in the case of a corresponding unpack instruction as described below.

In the illustrated embodiment, there are two predicate vector unpack instructions (UnpackPredHi and UnpackPredLo). Each instruction may be defined to unpack a different portion of the source predicate vector (in a source predicate vector register pi1) to the destination predicate vector (in the destination predicate vector register po1). The “low” portion of the vector may be the half of the vector on the left as illustrated in FIG. 4 (reference numeral 32), while the “high” portion of the vector may be the portion on the right (reference numeral 34 in FIG. 4). Other embodiments may define the high and low portions in the opposite fashion. In embodiments in which more than two predicate vectors are packed/unpacked, there may be more than two instructions and/or an operand may specify which portion of the source predicate vector is to be unpacked. In general, the portions (subvectors) may be non-overlapping and may be determined based on the unpack factor N. That is, the N subvectors, taken together, may cover the entire source vector and may be non-overlapping and equal in size. In other embodiments in which two subvectors are defined for unpacking, a single instruction with an operand specifying high or low may be used as well.

The vector attributes from the source predicate vector register may be modified and written to the destination as well. In an embodiment in which the vector attribute is a vector element size, the vector element may be multiplied by the unpack factor (e.g. 2, or N, in various embodiments). Number of vector elements/vector would be multiplied by the unpack factor and vector size/length would be unmodified.

The vector pack and unpack instructions (reference numeral 26 in FIG. 3) may be defined in a similar fashion to the vector predicate pack and unpack instructions, but operate on vectors rather than predicate vectors. Thus, the vector pack instruction (Pack) may take two source vector register operands (vi1 and vi2), reduce the size of the vector elements by the pack factor (2, or N in general), and write the result to the destination vector register vo1. The vector attribute for the destination vector may be provided by a source predicate vector register (pi1). In an embodiment, the vector attribute may be the vector element size. Accordingly, any number of vector element sizes may be supported by the processor 102 but one form of vector pack and unpack instructions may be used (e.g. there need not be separate pack and unpack instructions for each supported size). In one usage model, the predicate vector registers corresponding to vi1 and vi2 may be packed first using the PackPred instruction, and the destination vector predicate register may be used as the source predicate register for the vector pack instruction. Similarly, UnpackLo and UnpackHi instructions may be specified and may be controlled by vector attributes from source predicate vector registers, which may be destinations of predicate unpack instructions prior to the vector unpack instructions.

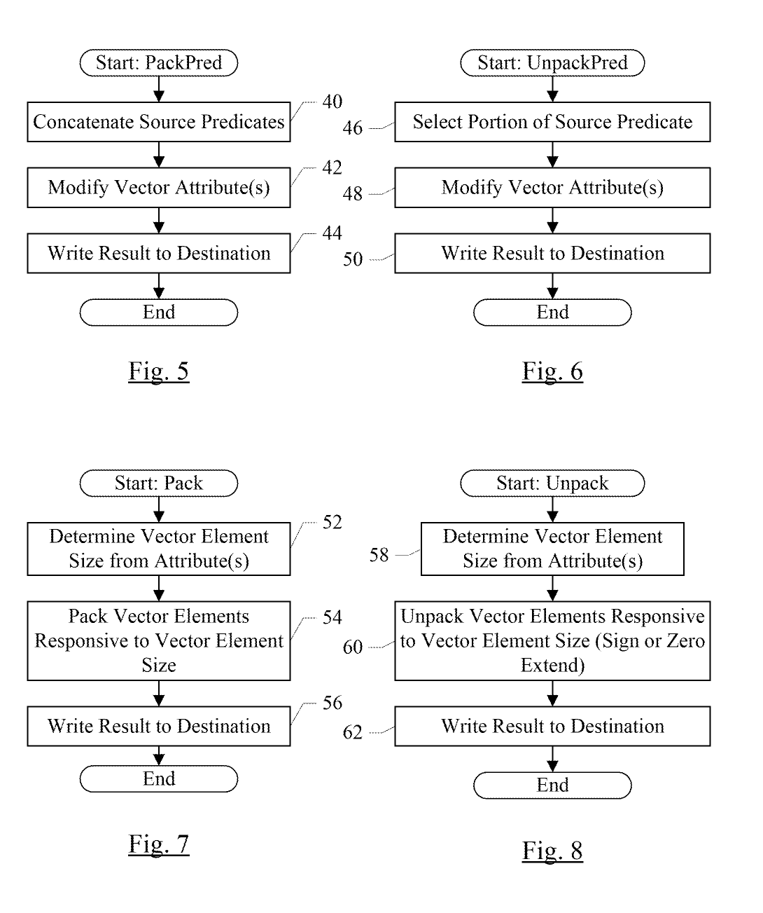

FIG. 5 is a flowchart illustrating operation of one embodiment of processor 102/execution core 10 in response to a predicate vector pack (PackPred) instruction. While blocks are shown in a particular order in FIG. 5, other orders may be used. Blocks may be performed in parallel in combinatorial logic circuitry in the processor 102/execution core 10. Blocks, combinations of blocks, and/or the flowchart as a whole may be pipelined over multiple clock cycles. The processor 102/execution core 10 may be configured to implement the operation illustrated in FIG. 5.

The processor 102/execution core 10 may be configured to concatenate the predicate vectors from the source predicate vector registers, generating an output predicate vector (block 40). The processor 102/execution core 10 may be configured to modify the vector attribute(s) from the source predicate vector register to generate the output vector attribute (block 42). The processor 102/execution core 10 may be configured to write the output predicate vector and the output vector attribute to the destination predicate vector register (block 44).

FIG. 6 is a flowchart illustrating operation of one embodiment of processor 102/execution core 10 in response to a predicate vector unpack (UnpackPredLo or UnpackPredHi) instruction. While blocks are shown in a particular order in FIG. 6, other orders may be used. Blocks may be performed in parallel in combinatorial logic circuitry in the processor 102/execution core 10. Blocks, combinations of blocks, and/or the flowchart as a whole may be pipelined over multiple clock cycles. The processor 102/execution core 10 may be configured to implement the operation illustrated in FIG. 6.

The processor 102/execution core 10 may be configured to select the portion (subvector) of the source predicate vector from the source predicate vector register, generating an output predicate vector (block 46). The processor 102/execution core 10 may be configured to modify the vector attribute(s) from the source predicate vector register to generate the output vector attribute (block 48). The processor 102/execution core 10 may be configured to write the output predicate vector and the output vector attribute to the destination predicate vector register (block 50).

FIG. 7 is a flowchart illustrating operation of one embodiment of processor 102/execution core 10 in response to a vector pack (Pack) instruction. While blocks are shown in a particular order in FIG. 7, other orders may be used. Blocks may be performed in parallel in combinatorial logic circuitry in the processor 102/execution core 10. Blocks, combinations of blocks, and/or the flowchart as a whole may be pipelined over multiple clock cycles. The processor 102/execution core 10 may be configured to implement the operation illustrated in FIG. 7.

The processor 102/execution core 10 may be configured to determine vector element size for the output vector responsive to the vector attribute from the source predicate vector register (block 52). The processor/execution core 10 may be configured to pack the vector elements from the source vectors, generating an output vector (block 54). The processor 102/execution core 10 may be configured to write the output vector to the destination vector register (block 56).

FIG. 8 is a flowchart illustrating operation of one embodiment of processor 102/execution core 10 in response to a vector unpack (UnpackLo or UnpackHi) instruction. While blocks are shown in a particular order in FIG. 8, other orders may be used. Blocks may be performed in parallel in combinatorial logic circuitry in the processor 102/execution core 10. Blocks, combinations of blocks, and/or the flowchart as a whole may be pipelined over multiple clock cycles. The processor 102/execution core 10 may be configured to implement the operation illustrated in FIG. 7.

The processor 102/execution core 10 may be configured to determine vector element size for the output vector responsive to the vector attribute from the source predicate vector register (block 58). The processor/execution core 10 may be configured to unpack the vector elements from the source vector portion, generating an output vector (block 60). In an embodiment, an operand of the vector unpack instruction may specify sign extension or zero extension for the expanded vector elements. Alternatively, different forms of the unpack vector instruction may specify sign or zero extension. The processor 102/execution core 10 may be configured to write the output vector to the destination vector register (block 62).

### Macroscalar Architecture Overview

Various embodiments of an instruction set architecture (referred to as the Macroscalar Architecture) and supporting hardware may allow compilers to generate program code for loops without having to completely determine parallelism at compile-time, and without discarding useful static analysis information, will now be described. The embodiments may include the check hazard instruction described above. Specifically, as described further below, a set of instructions is provided that does not mandate parallelism for loops but, instead, enables parallelism to be exploited at runtime if dynamic conditions permit. Accordingly, the architecture includes instructions that enable code generated by the compiler to dynamically switch between non-parallel (scalar) and parallel (vector) execution for loop iterations depending on conditions at runtime by switching the amount of parallelism used.

Thus, the architecture provides instructions that enable an undetermined amount of vector parallelism for loop iterations but do not require that the parallelism be used at runtime. More specifically, the architecture includes a set of vector-length agnostic instructions whose effective vector length can vary depending on runtime conditions. Thus, if runtime dependencies demand non-parallel execution of the code, then execution occurs with an effective vector length of one element. Likewise, if runtime conditions permit parallel execution, the same code executes in a vector-parallel manner to whatever degree is allowed by runtime dependencies (and the vector length of the underlying hardware). For example, if two out of eight elements of the vector can safely execute in parallel, a processor such as processor 102 may execute the two elements in parallel. In these embodiments, expressing program code in a vector-length agnostic format enables a broad range of vectorization opportunities that are not present in existing systems.

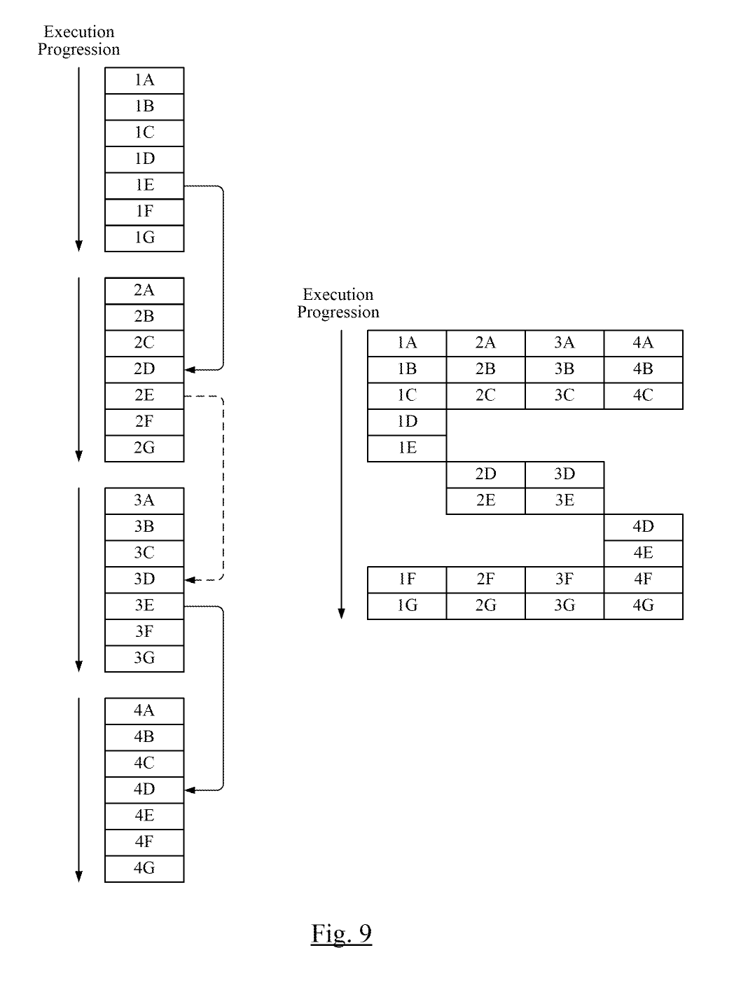

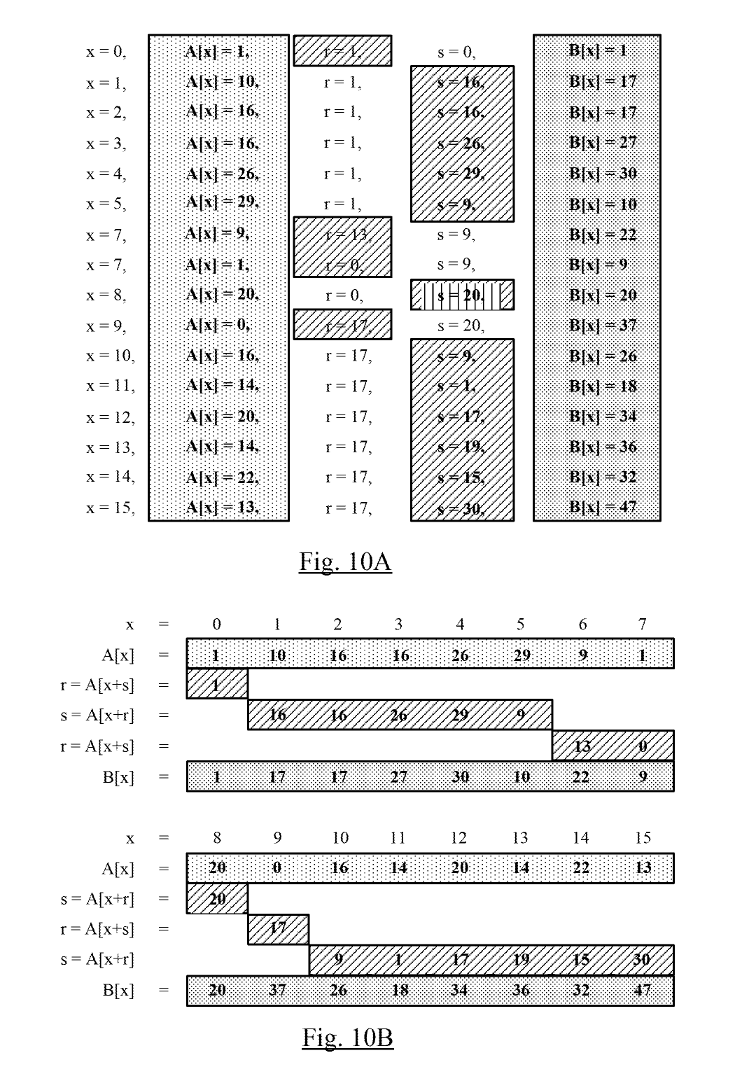

In various embodiments, during compilation, a compiler first analyzes the loop structure of a given loop in program code and performs static dependency analysis. The compiler then generates program code that retains static analysis information and instructs a processor such as processor 102, for example, how to resolve runtime dependencies and to process the program code with the maximum amount of parallelism possible. More specifically, the compiler may provide vector instructions for performing corresponding sets of loop iterations in parallel, and may provide vector-control instructions for dynamically limiting the execution of the vector instructions to prevent data dependencies between the iterations of the loop from causing an error. This approach defers the determination of parallelism to runtime, where the information on runtime dependencies is available, thereby allowing the software and processor to adapt parallelism to dynamically changing conditions. An example of a program code loop parallelization is shown in FIG. 9.

Referring to the left side of FIG. 9, an execution pattern is shown with four iterations (e.g., iterations 1-4) of a loop that have not been parallelized, where each loop includes instructions A-G. Serial operations are shown with instructions vertically stacked. On the right side of FIG. 9 is a version of the loop that has been parallelized. In this example, each instruction within an iteration depends on at least one instruction before it, so that there is a static dependency chain between the instructions of a given iteration. Hence, the instructions within a given iteration cannot be parallelized (i.e., instructions A-G within a given iteration are always serially executed with respect to the other instructions in the iteration). However, in alternative embodiments the instructions within a given iteration may be parallelizable.

As shown by the arrows between the iterations of the loop in FIG. 9, there is a possibility of a runtime data dependency between instruction E in a given iteration and instruction D of the subsequent iteration. However, during compilation, the compiler can only determine that there exists the possibility of data dependency between these instructions, but the compiler cannot tell in which iterations dependencies will actually materialize because this information is only available at runtime. In this example, a data dependency that actually materializes at runtime is shown by the solid arrows from 1E to 2D, and 3E to 4D, while a data dependency that doesn't materialize at runtime is shown using the dashed arrow from 2E to 3D. Thus, as shown, a runtime data dependency actually occurs between the first/second and third/fourth iterations.

Because no data dependency exists between the second and third iterations, the second and third iterations can safely be processed in parallel. Furthermore, instructions A-C and F-G of a given iteration have dependencies only within an iteration and, therefore, instruction A of a given iteration is able to execute in parallel with instruction A of all other iterations, instruction B can also execute in parallel with instruction B of all other iterations, and so forth. However, because instruction D in the second iteration depends on instruction E in the first iteration, instructions D and E in the first iteration must be executed before instruction D for the second iteration can be executed.

Accordingly, in the parallelized loop on the right side, the iterations of such a loop are executed to accommodate both the static and runtime data dependencies, while achieving maximum parallelism. More particularly, instructions A-C and F-G of all four iterations are executed in parallel. But, because instruction D in the second iteration depends on instruction E in the first iteration, instructions D and E in the first iteration must be executed before instruction D for the second iteration can be executed. However, because there is no data dependency between the second and third iterations, instructions D and E for these iterations can be executed in parallel.

### Examples of the Macroscalar Architecture

The following examples introduce Macroscalar operations and demonstrate their use in vectorizing loops such as the loop shown in FIG. 9 and described above in the parallelized loop example. For ease of understanding, these examples are presented using pseudocode in the C++ format.

It is noted that the following example embodiments are for discussion purposes. The instructions and operations shown and described below are merely intended to aid an understanding of the architecture. However, in alternative embodiments, instructions or operations may be implemented in a different way, for example, using a microcode sequence of more primitive operations or using a different sequence of sub-operations. Note that further decomposition of instructions is avoided so that information about the macro-operation and the corresponding usage model is not obscured.

### Notation

In describing the below examples, the following format is used for variables, which are vector quantities unless otherwise noted:

p5=a<b;

Elements of vector p5 are set to 0 or 1 depending on the result of testing a<b. Note that vector p5 may be a “predicate vector,” as described in more detail below. Some instructions that generate predicate vectors also set processor status flags to reflect the resulting predicates. For example, the processor status flags or condition-codes can include the FIRST, LAST, NONE, and/or ALL flags.

~p5; a=b+c;

Only elements in vector ‘a’ designated by active (i.e., non-zero) elements in the predicate vector p5 receive the result of b+c. The remaining elements of a are unchanged. This operation is called “predication,” and is denoted using the tilde (“~”) sign before the predicate vector.

!p5; a=b+c;

Only elements in vector ‘a’ designated by active (i.e., non-zero) elements in the predicate vector p5 receive the result of b+c. The remaining elements of a are set to zero. This operation is called “zeroing,” and is denoted using the exclamation point (“!”) sign before the predicate vector.

if (FIRST( )) goto ..; // Also LAST( ), ANY( ),
ALL( ), CARRY( ), ABOVE( ), or NONE( ), (where ANY(
) == !NONE( ))

The following instructions test the processor status flags and branch accordingly.

x+=VECLEN;

VECLEN is a machine value that communicates the number of elements per vector. The value is determined at runtime by the processor executing the code, rather than being determined by the assembler.

//Comment

In a similar way to many common programming languages, the following examples use the double forward slash to indicate comments. These comments can provide information regarding the values contained in the indicated vector or explanation of operations being performed in a corresponding example.

In these examples, other C++-formatted operators retain their conventional meanings, but are applied across the vector on an element-by-element basis. Where function calls are employed, they imply a single instruction that places any value returned into a destination register. For simplicity in understanding, all vectors are vectors of integers, but alternative embodiments support other data formats.

### Structural Loop-Carried Dependencies

In the code Example 1 below, a program code loop that is “non-vectorizable” using conventional vector architectures is shown. (Note that in addition to being non-vectorizable, this loop is also not multi-threadable on conventional multi-threading architectures due to the fine-grain nature of the data dependencies.) For clarity, this loop has been distilled to the fundamental loop-carried dependencies that make the loop unvectorizable.

In this example, the variables r and s have loop-carried dependencies that prevent vectorization using conventional architectures. Notice, however, that the loop is vectorizable as long as the condition (A [x]<FACTOR) is known to be always true or always false. These assumptions change when the condition is allowed to vary during execution (the common case). For simplicity in this example, we presume that no aliasing exists between A[ ] and B[ ].

### EXAMPLE 1

### Program Code Loop

r = 0;
s = 0;
for (x=0; x<KSIZE; ++x)
{

if (A[x] < FACTOR)
{

r = A[x+s];

}
else
{

s = A[x+r];

}
B[x] = r + s;

}

Using the Macroscalar architecture, the loop in Example 1 can be vectorized by partitioning the vector into segments for which the conditional (A[x]<FACTOR) does not change. Examples of processes for partitioning such vectors, as well as examples of instructions that enable the partitioning, are presented below. It is noted that for this example the described partitioning need only be applied to instructions within the conditional clause. The first read of A[x] and the final operation B[x]=r+s can always be executed in parallel across a full vector, except potentially on the final loop iteration.

Instructions and examples of vectorized code are shown and described to explain the operation of a vector processor such as processor 102 of FIG. 2, in conjunction with the Macroscalar architecture. The following description is generally organized so that a number of instructions are described and then one or more vectorized code samples that use the instructions are presented. In some cases, a particular type of vectorization issue is explored in a given example.

dest=VectorReadInt(Base, Offset)

VectorReadInt is an instruction for performing a memory read operation. A vector of offsets, Offset, scaled by the data size (integer in this case) is added to a scalar base address, Base, to form a vector of memory addresses which are then read into a destination vector. If the instruction is predicated or zeroed, only addresses corresponding to active elements are read. In the described embodiments, reads to invalid addresses are allowed to fault, but such faults only result in program termination if the first active address is invalid.

VectorWriteInt(Base, Offset, Value)

VectorWriteInt is an instruction for performing a memory write operation. A vector of offsets, Offset, scaled by the data size (integer in this case) is added to a scalar base address, Base, to form a vector of memory addresses. A vector of values, Value, is written to these memory addresses. If this instruction is predicated or zeroed, data is written only to active addresses. In the described embodiments, writes to illegal addresses always generate faults.

dest=VectorIndex(Start, Increment)

VectorIndex is an instruction for generating vectors of values that monotonically adjust by the increment from a scalar starting value specified by Start. This instruction can be used for initializing loop index variables when the index adjustment is constant. When predication or zeroing is applied, the first active element receives the starting value, and the increment is only applied to subsequent active elements. For example:

x=VectorIndex(0,1); // x={0 1 2 3 4 5 6 7}

dest=PropagatePostT(dest, src, pred)

The PropagatePostT instruction propagates the value of active elements in src, as determined by pred, to subsequent inactive elements of dest. Active elements, and any inactive elements that precede the first active element, remain unchanged in dest. The purpose of this instruction is to take a value that is conditionally calculated, and propagate the conditionally calculated value to subsequent loop iterations as occurs in the equivalent scalar code. For example:
Entry: dest={8 9 A B C D E F}
   src={1 2 3 4 5 6 7 8}
   pred={0 0 1 1 0 0 1 0}
Exit: dest={8 9 A B 4 4 E 7}

dest=PropagatePriorF(src, pred)

The PropagatePriorF instruction propagates the value of the inactive elements of src, as determined by pred, into subsequent active elements in dest. Inactive elements are copied from src to dest. If the first element of the predicate is active, then the last element of src is propagated to that position. For example:
Entry: src={1 2 3 4 5 6 7 8}
   pred={1 0 1 1 0 0 1 0}
Exit: dest={8 2 2 2 5 6 6 8}

dest=ConditionalStop(pred, deps)

The ConditionalStop instruction evaluates a vector of predicates, pred, and identifies transitions between adjacent predicate elements that imply data dependencies as specified by deps. The scalar value deps can be thought of as an array of four bits, each of which designates a possible transition between true/false elements in pred, as processed from left to right. These bits convey the presence of the indicated dependency if set, and guarantee the absence of the dependency if not set. They are:
kTF—Implies a loop-carried dependency from an iteration for which the predicate is true, to the subsequent iteration for which the value of the predicate is false.
kFF—Implies a loop-carried dependency from an iteration for which the predicate is false, to the subsequent iteration for which the value of the predicate is false.
kFT—Implies a loop-carried dependency from an iteration for which the predicate is false, to the subsequent iteration for which the value of the predicate is true.
kTT—Implies a loop-carried dependency from an iteration for which the predicate is true, to the subsequent iteration for which the value of the predicate is true.

The element position corresponding to the iteration that generates the data that is depended upon is stored in the destination vector at the element position corresponding to the iteration that depends on the data. If no data dependency exists, a value of 0 is stored in the destination vector at that element. The resulting dependency index vector, or DIV, contains a vector of element-position indices that represent dependencies. For the reasons described below, the first element of the vector is element number 1 (rather than 0).

As an example, consider the dependencies in the loop of Example 1 above. In this loop, transitions between true and false iterations of the conditional clause represent a loop-carried dependency that requires a break in parallelism. This can be handled using the following instructions:

| | |
|---|---|
| p1 = (t < FACTOR); | // p1 = {00001100} |

p2 = ConditionalStop(p1, kTF|kFT); // p2 = {00004060}

Because the 4th iteration generates the required data, and the 5th iteration depends on it, a 4 is stored in position 5 of the output vector p2 (which is the DIV). The same applies for the 7th iteration, which depends on data from the 6th iteration. Other elements of the DIV are set to 0 to indicate the absence of dependencies. (Note that in this example the first element of the vector is element number 1.)

dest=GeneratePredicates(Pred, DIV)

GeneratePredicates takes the dependency index vector, DIV, and generates predicates corresponding to the next group of elements that may safely be processed in parallel, given the previous group that was processed, indicated by pred. If no elements of Pred are active, predicates are generated for the first group of elements that may safely be processed in parallel. If Pred indicates that the final elements of the vector have been processed, then the instruction generates a result vector of inactive predicates indicating that no elements should be processed and the ZF flag is set. The CF flag is set to indicate that the last element of the results is active. Using the values in the first example, GeneratePredicates operates as follows:

| | |
|---|---|
| Entry Conditions: | // i2 = {0 0 0 0 4 0 6 0} |
| p2 = 0; | // p2 = {0 0 0 0 0 0 0 0} |

| Loop2: | |
|---|---|
| p2 = GeneratePredicates(p2,i2); | // p2′ = {1 1 1 1 0 0 |
| 0 0} | |
| CF = 0, ZF = 0 | |
| if(!PLAST( )) goto Loop2 | // p2″ = {0 0 0 0 1 1 |
| 0 0} | |
| CF = 0, ZF = 0 | // p2′″= {0 0 0 0 0 0 |

1 1}
CF = 1, ZF = 0

From an initialized predicate p2 of all zeros, GeneratePredicates generates new instances of p2 that partition subsequent vector calculations into three sub-vectors (i.e., p′, p″, and p′″). This enables the hardware to process the vector in groups that avoid violating the data dependencies of the loop.

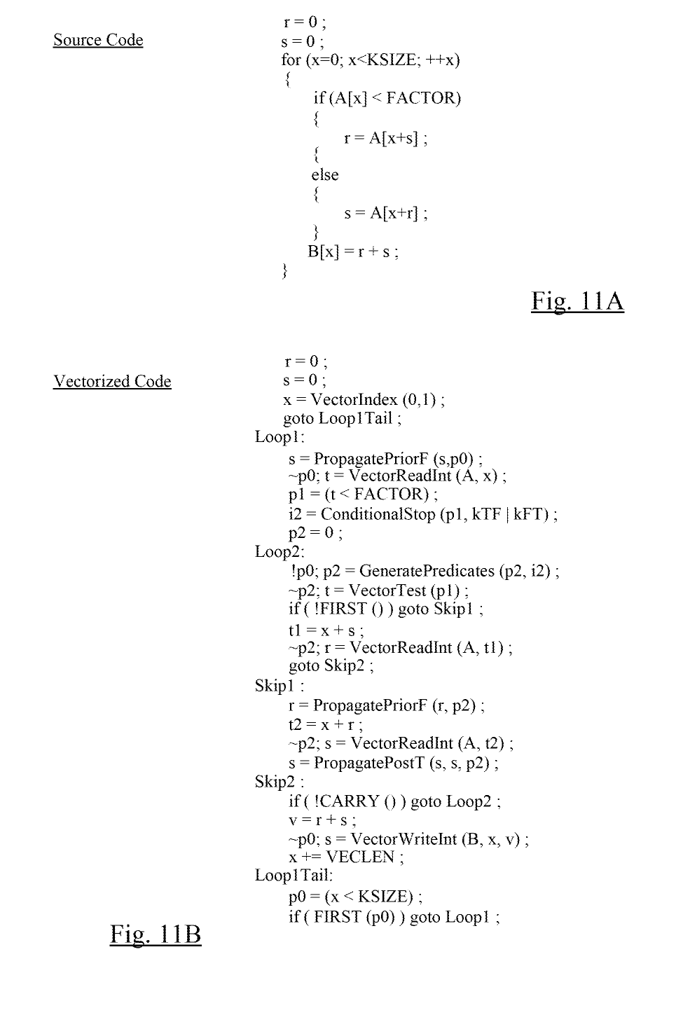

In FIG. 10A a diagram illustrating a sequence of variable states during scalar execution of the loop in Example 1 is shown. More particularly, using a randomized 50/50 distribution of the direction of the conditional expression, a progression of the variable states of the loop of Example 1 is shown. In FIG. 10B a diagram illustrating a progression of execution for Macroscalar vectorized program code of the loop of Example 1 is shown. In FIG. 10A and FIG. 10B, the values read from A[ ] are shown using leftward-slanting hash marks, while the values written to B[ ] are shown using rightward-slanting hash marks, and values for “r” or “s” (depending on which is changed in a given iteration) are shown using a shaded background. Observe that “r” never changes while “s” is changing, and vice-versa.

Nothing prevents all values from being read from A[ ] in parallel or written to B[ ] in parallel, because neither set of values participates in the loop-carried dependency chain. However, for the calculation of r and s, elements can be processed in parallel only while the value of the conditional expression remains the same (i.e., runs of true or false). This pattern for the execution of the program code for this loop is shown in of FIG. 10B. Note that the example uses vectors having eight elements in length. When processing the first vector instruction, the first iteration is performed alone (i.e., vector execution unit 204 processes only the first vector element), whereas iterations 1-5 are processed in parallel by vector execution unit 204, and then iterations 6-7 are processed in parallel by vector execution unit 204.

Referring to FIG. 11A and FIG. 11B, diagrams illustrating one embodiment of the vectorization of program code are shown. FIG. 11A depicts the original source code, while FIG. 11B illustrates the vectorized code representing the operations that may be performed using the Macroscalar architecture. In the vectorized code of FIG. 11B, Loop 1 is the loop from the source code, while Loop 2 is the vector-partitioning loop that processes the sub-vector partitions.

In the example, array A[ ] is read and compared in full-length vectors (i.e., for a vector of N elements, N positions of array A[ ] are read at once). Vector i2 is the DIV that controls partitioning of the vector. Partitioning is determined by monitoring the predicate p1 for transitions between false and true, which indicate loop-carried dependencies that should be observed. Predicate vector p2 determines which elements are to be acted upon at any time. In this particular loop, p1 has the same value in all elements of any sub-vector partition; therefore, only the first element of the partition needs to be checked to determine which variable to update.

After variable “s” is updated, the PropagatePostT instruction propagates the final value in the active partition to subsequent elements in the vector. At the top of the loop, the PropagatePriorF instruction copies the last value of “s” from the final vector position across all elements of the vector in preparation for the next pass. Note that variable “r” is propagated using a different method, illustrating the efficiencies of using the PropagatePriorF instruction in certain cases.

### Software Speculation

In the previous example, the vector partitions prior to the beginning of the vector-partitioning loop could be determined because the control-flow decision was independent of the loop-carried dependencies. However, this is not always the case. Consider the following two loops shown in Example 2A and Example 2B:

### EXAMPLE 2A

### Program Code Loop 1

j = 0;
for (x=0; x<KSIZE; ++x)
{

if (A[x] < FACTOR)
{

j = A[x+j];

}
B[x] = j;

}

### EXAMPLE 2B

### Program Code Loop 2

j = 0;
for (x=0; x<KSIZE; ++x)
{

if (A[x+j] < FACTOR)
{

j = A[x];

}
B[x] = j;

}

In Example 2A, the control-flow decision is independent of the loop-carried dependency chain, while in Example 2B the control flow decision is part of the loop-carried dependency chain. In some embodiments, the loop in Example 2B may cause speculation that the value of “j” will remain unchanged and compensate later if this prediction proves incorrect. In such embodiments, the speculation on the value of “j” does not significantly change the vectorization of the loop.

In some embodiments, the compiler may be configured to always predict no data dependencies between the iterations of the loop. In such embodiments, in the case that runtime data dependencies exist, the group of active elements processed in parallel may be reduced to represent the group of elements that may safely be processed in parallel at that time. In these embodiments, there is little penalty for mispredicting more parallelism than actually exists because no parallelism is actually lost (i.e., if necessary, the iterations can be processed one element at a time, in a non-parallel way). In these embodiments, the actual amount of parallelism is simply recognized at a later stage.

dest=VectorReadIntFF(Base, Offset, pf)

VectorReadIntFF is a first-faulting variant of VectorReadInt. This instruction does not generate a fault if at least the first active element is a valid address. Results corresponding to invalid addresses are forced to zero, and flags pf are returned that can be used to mask predicates to later instructions that use this data. If the first active element of the address is unmapped, this instruction faults to allow a virtual memory system in computer system 100 (not shown) to populate a corresponding page, thereby ensuring that processor 102 can continue to make forward progress.

dest=Remaining(Pred)

The Remaining instruction evaluates a vector of predicates, Pred, and calculates the remaining elements in the vector. This corresponds to the set of inactive predicates following the last active predicate. If there are no active elements in Pred, a vector of all active predicates is returned. Likewise, if Pred is a vector of all active predicates, a vector of inactive predicates is returned. For example:
Entry: pred={0 0 1 0 1 0 0 0}
Exit: dest={0 0 0 0 0 1 1 1}

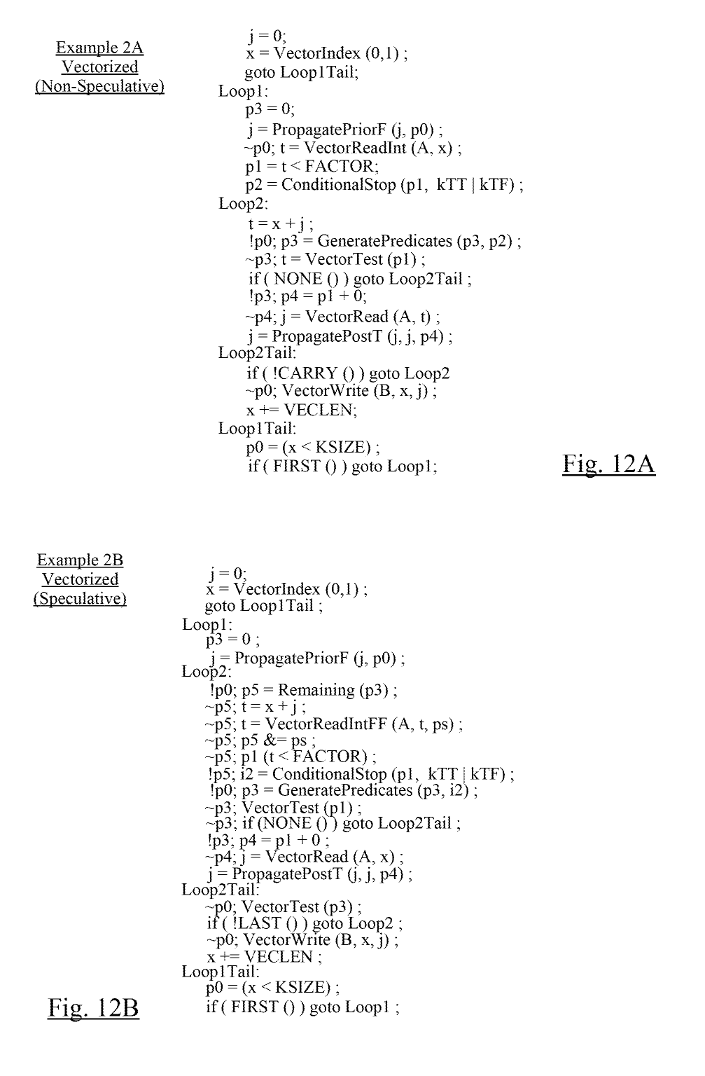

FIG. 12A and FIG. 12B are diagrams illustrating embodiments of example vectorized program code. More particularly, the code sample shown in FIG. 12A is a vectorized version of the code in Example 2A (as presented above). The code sample shown in FIG. 12B is a vectorized version of the code in Example 2B. Referring to FIG. 12B, the read of A[ ] and subsequent comparison have been moved inside the vector-partitioning loop. Thus, these operations presume (speculate) that the value of “j” does not change. Only after using “j” is it possible to determine where “j” may change value. After “j” is updated, the remaining vector elements are re-computed as necessary to iterate through the entire vector. The use of the Remaining instruction in the speculative code sample allows the program to determine which elements remain to be processed in the vector-partitioning loop before the program can determine the sub-group of these elements that are actually safe to process (i.e., that don't have unresolved data dependencies).

In various embodiments fault-tolerant read support is provided. Thus, in such embodiments, processor 102 may speculatively read data from memory using addresses from invalid elements of a vector instruction (e.g., VectorReadFF) in an attempt to load values that are to be later used in calculations. However, upon discovering that an invalid read has occurred, these values are ultimately discarded and, therefore, not germane to correct program behavior. Because such reads may reference non-existent or protected memory, these embodiments may be configured to continue normal execution in the presence of invalid but irrelevant data mistakenly read from memory. (Note that in embodiments that support virtual memory, this may have the additional benefit of not paging until the need to do so is certain.)

In the program loops shown in FIG. 12A and FIG. 12B, there exists a loop-carried dependency between iterations where the condition is true, and subsequent iterations, regardless of the predicate value for the later iterations. This is reflected in the parameters of the ConditionalStop instruction.

The sample program code in FIG. 12A and FIG. 12B highlights the differences between non-speculative and speculative vector partitioning. More particularly, in Example 2A memory is read and the predicate is calculated prior to the ConditionalStop. The partitioning loop begins after the ConditionalStop instruction. However, in Example 2B, the ConditionalStop instruction is executed inside the partitioning loop, and serves to recognize the dependencies that render earlier operations invalid. In both cases, the GeneratePredicates instruction calculates the predicates that control which elements are used for the remainder of the partitioning loop.

In the previous examples, the compiler was able to establish that no address aliasing existed at the time of compilation. However, such determinations are often difficult or impossible to make. The code segment shown in Example 3 below illustrates how loop-carried dependencies occurring through memory (which may include aliasing) are dealt with in various embodiments of the Macroscalar architecture.

### EXAMPLE 3

### Program Code Loop 3

for (x=0; x<KSIZE; ++x)
{

r = C[x];
s = D[x];
A[x] = A[r] + A[s];

}

In the code segment of EXAMPLE 3, the compiler cannot determine whether A[x] aliases with A[r] or A[s]. However, with the Macroscalar architecture, the compiler simply inserts instructions that cause the hardware to check for memory hazards at runtime and partitions the vector accordingly at runtime to ensure correct program behavior. One such instruction that checks for memory hazards is the CheckHazardP instruction which is described below.

dest=CheckHazardP (first, second, pred)

The CheckHazardP instruction examines two vectors of a memory address (or indices) corresponding to two memory operations for potential data dependencies through memory. The vector ‘first’ holds addresses for the first memory operation, and vector ‘second’ holds the addresses for the second operation. The predicate ‘pred’ indicates or controls which elements of ‘second’ are to be operated upon. As scalar loop iterations proceed forward in time, vector elements representing sequential iterations appear left to right within vectors. The CheckHazardP instruction may evaluate in this context. The instruction may calculate a DIV representing memory hazards between the corresponding pair of first and second memory operations. The instruction may correctly evaluates write-after-read, read-after-write, and write-after-write memory hazards. The CheckHazardP instruction may be an embodiment of the check hazard instruction described previously.

As with the ConditionalStop instruction described above, the element position corresponding to the iteration that generates the data that is depended upon may be stored in the destination vector at the element position corresponding to the iteration that is dependent upon the data. If no data dependency exists, a zero may be stored in the destination vector at the element position corresponding to the iteration that does not have the dependency. For example:
Entry: first={2 3 4 5 6 7 8 9}
   second={8 7 6 5 4 3 2 1}
   pred={1 1 1 1 1 1 1 1}
Exit: dest={0 0 0 0 3 2 1 0}

As shown above, element 5 of the first vector (“first”) and element 3 of the second vector (“second”) both access array index 6. Therefore, a 3 stored in position 5 of DIV. Likewise, element 6 of first and element 2 of second both access array index position 7, causing a 2 to be stored in position 6 of DIV, and so forth. A zero is stored in the DIV where no data dependencies exist.

In some embodiments, the CheckHazardP instruction may account for various sizes of data types. However, for clarity we describe the function of the instruction using only array index types.

The memory access in the example above has three memory hazards. However, in the described embodiments, only two partitions may be needed to safely process the associated memory operations. More particularly, handling the first hazard on element position 3 renders subsequent dependencies on lower or equally numbered element positions moot. For example:

| | | |
|---|---|---|
| Entry Conditions: | //DIV | = {0 0 0 0 3 2 1 0} |
| | // p2 | = {0 0 0 0 0 0 0 0} |
| p2 = GeneratePredicates(p2,DIV); | // p2 | = {1 1 1 1 0 0 0 0} |
| P2 = GeneratePredicates(p2,DIV) | // p2 | = {0 0 0 0 1 1 1 1} |

The process used by the described embodiments to analyze a DIV to determine where a vector should be broken is shown in pseudocode below. In some embodiments, the vector execution unit 204 of processor 102 may perform this calculation in parallel. For example:

List = <empty>;
for (x=STARTPOS; x<VECLEN; ++x)
{

if(DIV[x] in List)

Break from loop;

else if(DIV[x]>0)

Append <x> to List;

}

The vector may safely be processed in parallel over the interval [STARTPOS,x), where x is the position where DIV[x]>0. That is, from STARTPOS up to (but not including) position x, where STARTPOS refers to the first vector element after the set of elements previously processed. If the set of previously processed elements is empty, then STARTPOS begins at the first element.

In some embodiments, multiple DIVs may be generated in code using ConditionalStop and/or CheckHazardP instructions. The GeneratePredicates instruction, however, uses a single DIV to partition the vector. There are two methods for dealing with this situation: (1) partitioning loops can be nested; or (2) the DIVs can be combined and used in a single partitioning loop. Either approach yields correct results, but the optimal approach depends on the characteristics of the loop in question. More specifically, where multiple DIVS are expected not to have dependencies, such as when the compiler simply cannot determine aliasing on input parameters, these embodiments can combine multiple DIVs into one, thus reducing the partitioning overhead. On the other hand, in cases with an expectation of many realized memory hazards, these embodiments can nest partitioning loops, thereby extracting the maximum parallelism possible (assuming the prospect of additional parallelism exists).

In some embodiments, DIVs may be combined using a VectorMax(A,B) instruction as shown below.

| | |
|---|---|
| i2 = CheckHazardP(a,c,p0); | //i2 = {0 0 2 0 2 4 0 0} |
| i3 = CheckHazardP(b,c,p0); | //i3 = {0 0 1 3 3 0 0 0} |
| ix = VectorMax(i2,i3); | //ix = {0 0 2 3 3 4 0 0} |

Because the elements of a DIV should only contain numbers less than the position of that element, which represent dependencies earlier in time, later dependencies only serve to further constrain the partitioning, which renders lower values redundant from the perspective of the GeneratePredicates instruction. Thus, taking the maximum of all DIVs effectively causes the GeneratePredicates instruction to return the intersection of the sets of elements that can safely be processed in parallel.

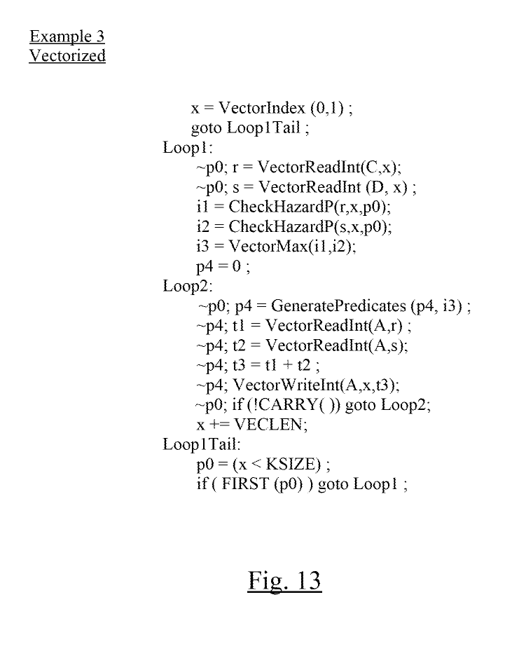

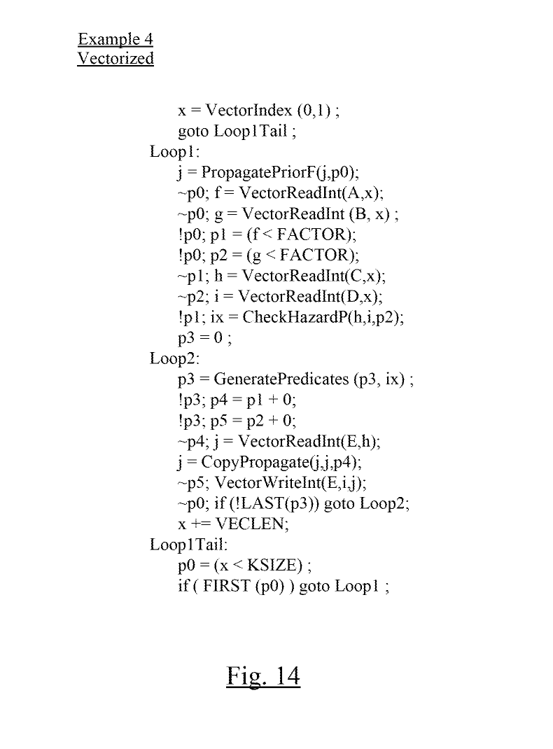

FIG. 13 is a diagram illustrating one embodiment of example vectorized program code. More particularly, the code sample shown in FIG. 13 is a vectorized version of the code in Example 3 (as presented above). Referring to FIG. 13, no aliasing exists between C[] or D[] and A[], but operations on A[] may alias one another. If the compiler is unable to rule out aliasing with C[] or D[], the compiler can generate additional hazard checks. Because there is no danger of aliasing in this case, the read operations on arrays C[] and D[] have been positioned outside the vector-partitioning loop, while operations on A[] remain within the partitioning loop. If no aliasing actually exists with A[], the partitions retain full vector size, and the partitioning loop simply falls through without iterating. However, for iterations where aliasing does occur, the partitioning loop partitions the vector to respect the data dependencies thereby ensuring correct operation.

In the embodiment shown in the code segment of FIG. 13, the hazard check is performed across the entire vector of addresses. In the general case, however, it is often necessary to check hazards between conditionally executed memory operations. The CheckHazardP instruction takes a predicate that indicates which elements of the second memory operation are active. If not all elements of the first operation are active, the CheckHazardP instruction itself can be predicated with a zeroing predicate corresponding to those elements of the first operand which are active. (Note that this may yield correct results for the cases where the first memory operation is predicated.)

The code segment in Example 4 below illustrates a loop with a memory hazard on array E[]. The code segment conditionally reads and writes to unpredictable locations within the array. In FIG. 14 a diagram illustrating one embodiment of example vectorized program code is shown. More particularly, the code sample shown in FIG. 14 is a vectorized Macroscalar version of the code in Example 4 (as presented above).

### EXAMPLE 4

### Program Code Loop 4

j = 0;
for (x=0; x<KSIZE; ++x)
{

f = A[x];
g = B[x];
if (f < FACTOR)
{

h = C[x];
j = E[h];

}
if (g < FACTOR)
{

i = D[x];
E[i] = j;

}

}

Referring to FIG. 14, the vectorized loop includes predicates p1 and p2 which indicate whether array E[] is to be read or written, respectively. The CheckHazardP instruction checks vectors of addresses (h and i) for memory hazards. The parameter p2 is passed to CheckHazardP as the predicate controlling the second memory operation (the write). Thus, CheckHazardP identifies the memory hazard(s) between unconditional reads and conditional writes predicated on p2. The result of CheckHazardP is zero-predicated in p1. This places zeroes in the DIV(ix) for element positions that are not to be read from E[]. Recall that a zero indicates no hazard. Thus, the result, stored in ix, is a DIV that represents the hazards between conditional reads predicated on p1 and conditional writes predicated on p2. This is made possible because non-hazard conditions are represented with a zero in the DIV.

It is noted that in the above embodiments, to check for memory-based hazards, the CheckHazardP instruction was used. As described above, the CheckHazardP instruction takes a predicate as a parameter that controls which elements of the second vector are operated upon. However, in other embodiments other types of CheckHazard instructions may be used. In one embodiment, this version of the CheckHazard instruction may simply operate unconditionally on the two input vectors. Regardless of which version of the CheckHazard instruction is employed, it is noted that as with any Macroscalar instruction that supports result predication and/or zeroing, whether or not the a given element of a result vector is modified by execution of the CheckHazard instruction may be separately controlled through the use of a predicate vector or zeroing vector, as described above. That is, the predicate parameter of the CheckHazardP instruction controls a different aspect of instruction execution than the general predicate/zeroing vector described above.

Numerous variations and modifications will become apparent to those skilled in the art once the above disclosure is fully appreciated. It is intended that the following claims be interpreted to embrace all such variations and modifications.

What is claimed is:

1. A processor comprising:
a register file comprising a plurality of predicate registers, wherein each predicate register stores an attribute and a plurality of predicates during use; and
an execution core coupled to the register file, wherein the execution core is configured to execute a first instruction to generate a result predicate for a destination predicate register of the first instruction responsive to at least one source predicate from a source predicate register of the first instruction and configured to generate a result attribute for the destination predicate register as a function of a source attribute from the source predicate register.

2. The processor as recited in claim 1 wherein the first instruction is a predicate pack instruction, and wherein the at least one source predicate comprises at least the source predicate from the source predicate register and a second predicate from a second source predicate register of the first instruction, and wherein the result predicate comprises the source predicate concatenated with the second predicate.

3. The processor as recited in claim 2 wherein the attribute is a vector element size, and wherein the result attribute is equal to the source attribute divided by a number of the source predicates.

4. The processor as recited in claim 2 wherein the attribute is a number of vector elements per vector, and wherein the result attribute is equal to the source attribute multiplied by a number of the source predicates.

5. The processor as recited in claim 2 wherein the attribute is a vector length, and wherein the result attribute is equal to the source attribute.

6. The processor as recited in claim 1 wherein the first instruction is a predicate unpack instruction, and wherein the result predicate comprises a portion of the source predicate.

7. The processor as recited in claim 6 wherein the attribute is a vector element size, and wherein the result attribute is equal to the source attribute multiplied by a number of the portions in the source predicate.

8. The processor as recited in claim 6 wherein the attribute is a number of vector elements, and wherein the result attribute is equal to the first attribute divided by the number of the portions in the source predicate.

9. The processor as recited in claim 6 wherein the attribute is a vector length, and wherein the result attribute is equal to the source attribute.

10. A method comprising a processor executing a first instruction defined in an instruction set architecture implemented by the processor, wherein the executing comprises:
generating a result predicate for a destination predicate register of the first instruction responsive to at least one source predicate from a source predicate register of the first instruction; and
generating a result attribute for the destination predicate register as a function of a source attribute of the source predicate register.

11. The method as recited in claim 10 wherein the first instruction is a predicate pack instruction, and wherein the at least one source predicate comprises at least the source predicate from the source predicate register and a second predicate from a second source predicate register of the first instruction, and wherein generating the result predicate comprises concatenating the source predicate with the second predicate.

12. The method as recited in claim 11 wherein the attribute is a vector element size, and wherein generating the result attribute comprises dividing the source attribute by a number of the source predicates.

13. The method as recited in claim 10 wherein the first instruction is a predicate unpack instruction, and wherein the result predicate comprises a portion of the source predicate, where a number of the portions in the source predicate is equal to an unpacking factor.

14. The method as recited in claim 13 wherein the attribute is a vector element size, and wherein the result attribute is equal to the source attribute multiplied by the unpacking factor.

15. A processor comprising:
a register file comprising a plurality of vector registers and a plurality of predicate registers, wherein each predicate register stores an attribute and a plurality of predicates during use, and wherein each vector register stores a vector during use, each vector have a plurality of vector elements; and
an execution core coupled to the register file, wherein the execution core is configured to execute a first instruction to generate a result vector as a function of at least one source vector from a source vector register of the first instruction and wherein the operation of the function is based on a source attribute from a source predicate register of the first instruction.

16. The processor as recited in claim 15 wherein the first instruction is a pack instruction, and wherein the at least one source vector comprises a number of source vectors, wherein the number depends on the source attribute.

17. The processor as recited in claim 16 wherein the execution core is configured to reduce a size of each vector element of the source vectors responsive to the pack instruction.

18. The processor as recited in claim 15 wherein the first instruction is an unpack instruction, and wherein the execution core is configured to increase a size of each vector element of the source vector responsive to the pack instruction.

19. The processor as recited in claim 18 wherein the execution core is configured to zero extend each vector element.

20. The processor as recited in claim 18 wherein the execution core is configured to sign extend each vector element.
